(19) United States
(12) Patent Application Publication
(10) Pub. No.: US 2010/0176255 A1
(43) Pub. Date: Jul. 15, 2010

(54) QUICK LIFT COMPUTER STAND

(76) Inventor: Joseph C. Cavella, Malibu, CA (US)

Correspondence Address: GREGORY J. GORE, 70 WEST OAKLAND AVENUE, SUITE 316, DOYLESTOWN, PA, 18901, US

(21) Appl. No.: 12/354,438

(22) Filed: Jan. 15, 2009

(51) Int. Cl. F16M 11/24

(52) U.S. Cl. 248/157

(57) ABSTRACT

The present invention comprises a computer support stand that rests upon a support surface and provides a front deck that can support a computer display monitor, a keyboard and a mouse pad that can be easily and quickly raised or lowered manually by a computer operator. The front deck is slidably coupled to two vertical support posts. Brake-release side levers encased by elastomeric boots release spring-loaded brake means that secure the front deck to the vertical support posts. Cable and pulley means attach the front deck to a horizontally disposed rear counterbalance tray that is likewise slidably coupled to the vertical support posts. The rear tray provides a support surface for a computer system case and computer accessories that substantially counterbalances the combined weight of the front deck, display monitor, keyboard and mouse pad.

### FIELD OF THE INVENTION

This invention relates to vertically adjustable support stands. More specifically, it relates to computer workstations in which the computer operator monitor, keypad and mouse pad work surface can be manually raised or lowered quickly.

### BACKGROUND OF THE INVENTION AND PRIOR ART

The computer operator of a desktop or laptop computer who sits for multiple hours at his work station commonly suffers a plethora of health problems plus loss of mental concentration, reduced work output, increased errors and low morale. The work ethic of the conscientious computer operator discourages his or her leaving the work station until mental and physical discomfort reaches an intolerable level and drives said computer operator to abandon work to seek relief. Prior art adjustable height computer desks, tables and workstations are designed to vary the height of the work surface of the computer operator remaining in the sitting position and therefore employ cumbersome gears and electromechanical systems to adjust the vertical height of the work surface substantially permanently.

There is therefore a need in the art for a computer workstation in which the computer operator can easily, quickly and temporarily raise the work surface manually to provide freedom to quickly rise to a standing position, thereby permitting muscular movement to relieve muscular tension and achieve enhanced circulation.

The most pertinent prior art of which the Applicant is aware includes U.S. Pat. No. 6,550,724 issued Apr. 22, 2003 entitled “Sit/stand Console Structure”; U.S. Pat. No. 5,526,756 issued Jun. 18, 1996 entitled “Adjustable Computer Desk”; U.S. Pat. No. 5,402,736 issued Apr. 4, 1995 entitled “Table Having a Tabletop Adjustable to Selectable Levels”; U.S. Pat. No. 5,598,789 entitled “Vertically Adjustable Table”; U.S. Pat. No. 5,845,590 issued Dec. 8, 1998 entitled “Adjustable Height Table”; U.S. Pat. No. 6,119,605 issued Sep. 19, 2000 entitled “Height Adjustable Table with Counterbalance Spring and Load Indicator”; U.S. Pat. No. 6,220,185 issued Apr. 24, 2001 entitled “Table, in Particular for Video Workstations”; U.S. Pat. No. 6,289,825 issued Sep. 18, 2001 entitled “Adjustment Mechanism for Workstation”; U.S. Pat. No. 5,289,782 issued Mar. 1, 1994 entitled “Adjustable Height Table”; U.S. Pat. No. 4,637,322 issued Jan. 20, 1987 entitled “Adjustable Computer Work Table”; U.S. Pat. No. 5,685,231 issued Nov. 11, 1997 entitled “Computer Work Station”; and U.S. Pat. No. 4,619,208 issued Oct. 28, 1986 entitled “Work Surface Height Adjustment Mechanism”.

### SUMMARY OF INVENTION

To meet the needs in the art, the present invention is designed to permit the computer operator to attain relief from fatigue and poor circulation by manually raising the height of the work surface, hereinafter referred to as the front deck, by grasping the sides of said front deck as the operator raises his body to a standing position. The front deck provides a surface on which to place the display monitor, keyboard and mouse pad. A rear tray connected by cable and pulley means to the front deck affords said operator a surface on which to place the desktop computer system case, thereby substantially counterbalancing the weight of said front deck, display monitor, keyboard and mouse pad, a combined weight commonly 30 lbs. Said computer operator may alternately select to load the rear tray with computer-related CD's and manuals to thereby vary the counterbalance weight for the purpose of benefiting from health enhancing weight-bearing exercise. Said operator can seamlessly continue working in the standing position while flexing body members and loosening stiff muscles thereby increasing circulation. When said computer operator feels sufficiently recovered, he grasps said front deck and manually lowers it as he returns to sitting position. The ease and simplicity with which said computer operator alternates sitting and standing motions plus the selectable weight-bearing benefits afford said computer operator the means to maintain physical well-being and mental concentration and to continue productive work with minimal interruption.

The present invention differs from current vertically adjustable work stations by providing a work surface that is vertically raised or lowered by the intuitive clasping of the side edges of the work surface and simply raising or lowering it as the operator rises or sits. This availability of effortless, instantaneous changing of the work surface height thus provides the computer operator with the opportunity to stretch his or her legs for a few seconds or few minutes or many minutes. Also, the present invention's simple construction provides a low cost workstation that addresses fatigue and health concerns of computer operators and the bottom line concerns of employers of computer operators. Additionally, current adjustable workstations are stand-alone structures that use up valuable floor space. In its preferred embodiment, the present invention can be readily moved and placed upon any existing desk or table and thus does not use up additional floor space.

More specifically, the Applicant has invented an adjustable height computer work stand comprising a frame including two vertical support posts. A front deck is slidably affixed to the support posts moveable between the uppermost and lowermost position. The deck is adapted to horizontally support a computer display monitor, a keyboard and a mouse pad. A rear counterbalance tray is slidably affixed to the support posts being moveable between an uppermost and lowermost position. The tray is adapted to horizontally support a computer system case and computer accessories. Cable and pulley means are mechanically connected between the deck and the tray whereby the tray and the deck are counterbalanced such that the downward movement of the deck causes the upper movement of the tray. The support posts are preferably located on opposite sides of the frame between the front deck and the rear deck. Pulley means are supported on a shaft, which extends between the vertical support posts. Brake means are included for releasably securing the front deck to the vertical support posts. Brake means include release levers which are encased in elastomeric boots. The combined weight of the front deck, the display monitor, the keyboard and the mouse pad is approximately equal to the combined weight of the rear tray, the computer system case and the computer accessories.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a top left front perspective view of the invention.

FIG. 2 is a left front enlarged sectional view of the top left portion of the invention.

FIG. 3 is a top left front exploded perspective view.

FIG. 4 is a left front enlarged exploded perspective view of the L-shaped left support arm of the front deck of the invention, of which the L-shaped right support arm is a mirror image.

FIG. 5 is an enlarged perspective view of the left side vertical tracks and rollers of which the right side vertical tracks are a mirror image.

FIG. 6 is an enlarged top sectional view of the left side brake and release mechanism, of which the right side brake and release mechanism is a mirror image

### DETAILED DESCRIPTION OF THE PREFERRED EMBODIMENT

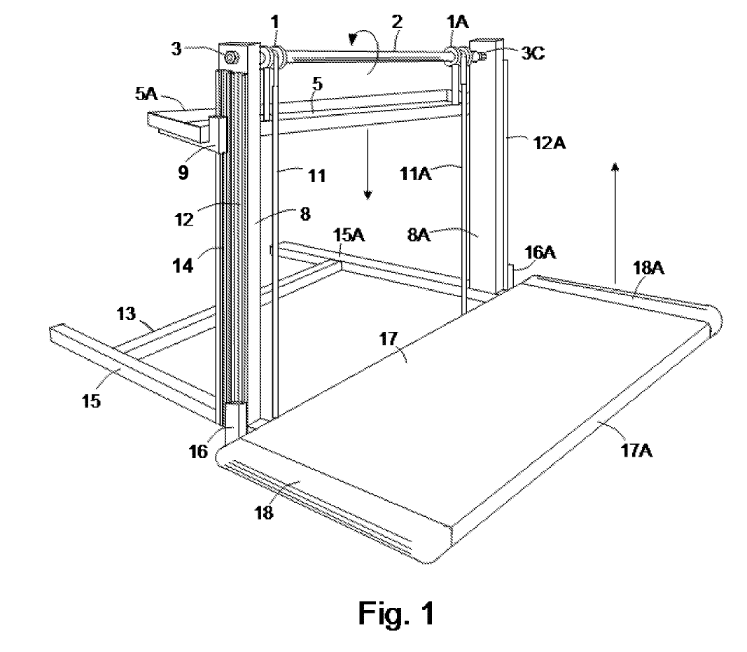

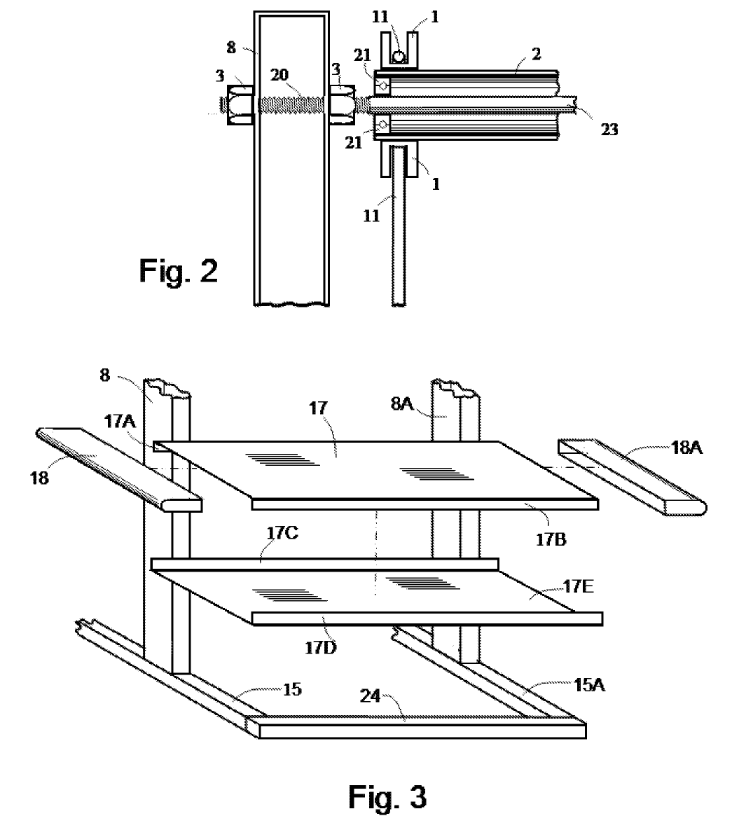

FIG. 1 shows the overall construction of the present invention consisting of horizontal structural members 15 and 15A that extend beneath the work surface 17 hereinafter referred to as the front deck, which is fitted on the right side edge and the left side edge with compressible elastomeric boots 18 and 18A that house the brake release levers that are depressed at the option of the operator while he or she grasps the sides of the front deck 17. Cross structural member 13 is affixed to stabilize the horizontal structural members 15 and 15A. Partially shown is the short end of the L-shaped front deck support arm 16 which is slidably coupled to the frontward track 12 hereinafter referred to as the front deck track. Rearward to the front deck track 12 is affixed the rear tray track 14. Both of these similar side by side tracks are fastened to the leftward vertical support post 8 which is securely affixed to horizontal structural member 15. Rightward is a similar vertical support post 8A affixed to horizontal structural member 15A. Affixed to the rightward vertical support post 8A are similar mirror-image track arrangements with only the edge of the front deck track 12A shown. Near the top of the drawing is shown the rear tray 5 bordered on four sides by a retainer lip 5A. The L-shaped rear tray support arm 9 is affixed to the rear tray 5 near the edge of the rear tray 5. A similar mirrored L-shaped rear tray support arm (not shown) is affixed near the right edge of the rear tray 5. Above the rear tray 5 is the cable support shaft 2 on which are mounted two cable reels 1 and 1A over which cables 11 and 11A are looped, whose ends are securely affixed to the front deck 17 and to the rear tray 5. Cable support shaft 2 is bearingly supported by a connecting rod (shown in FIG. 2, 23) that is enclosed by the cable support shaft 2. The rightward end of the connecting rod continues through the rightward vertical support post 8A and is secured by a securing nut 3C on the inner side of the rightward vertical support post 8A and a securing nut (not shown) on the outer side of the rightward vertical support post 8A. The leftward end of the connecting rod continues through the leftward vertical support post 8 and is secured by a securing nut (not shown) on the inner side of the leftward vertical support post 8 and a securing nut 3 on the outer side of the leftward vertical support post 8.

FIG. 2 shows a front sectional view of the leftward end of the cable support shaft 2 and the top of the leftward vertical support post 8. Ball bearing 21 supports a connecting rod 23 that is enclosed by the cable support shaft 2. The connecting rod 23 is threaded 20 at both ends and projects beyond the length of the cable support shaft 2 through an opening in the leftward vertical support post 8 where it is secured by a securing nut 3 on the outer side of the vertical support post 8 and a securing nut 3B on the inner side of the vertical support post 8. Reel 1 is mounted on cable support shaft 2 and provides the channel for cable 11. Similar mirror-image components (not shown) are duplicated on the rightward side of the cable support shaft 2. Reel 1 and cable 11 and their mirror-image components (shown in FIG. 1 as 1A and 11A) provide the connecting means between rear tray (not shown) and front deck (not shown).

FIG. 3 shows an exploded view of the front deck 17 and its relationship to the horizontal support structure 15, 15A, 24. The uppermost front deck plate 17 provides the work surface and is dimensionally configured to fit over the lowermost plate 17E with flanges 17A and 17B overlooking flanges 17C and 17D of bottom plate 17E for transverse rigidity. Elastomeric boots 18 and 18A close the ends of the front deck assembly and provide a cushioning housing for the leftward and rightward brake release levers (not shown). Vertical support posts 8 and 8A are rigidly affixed to horizontal structural members 15 and 15A which extend forward and are affixed to frontward horizontal structural member 24.

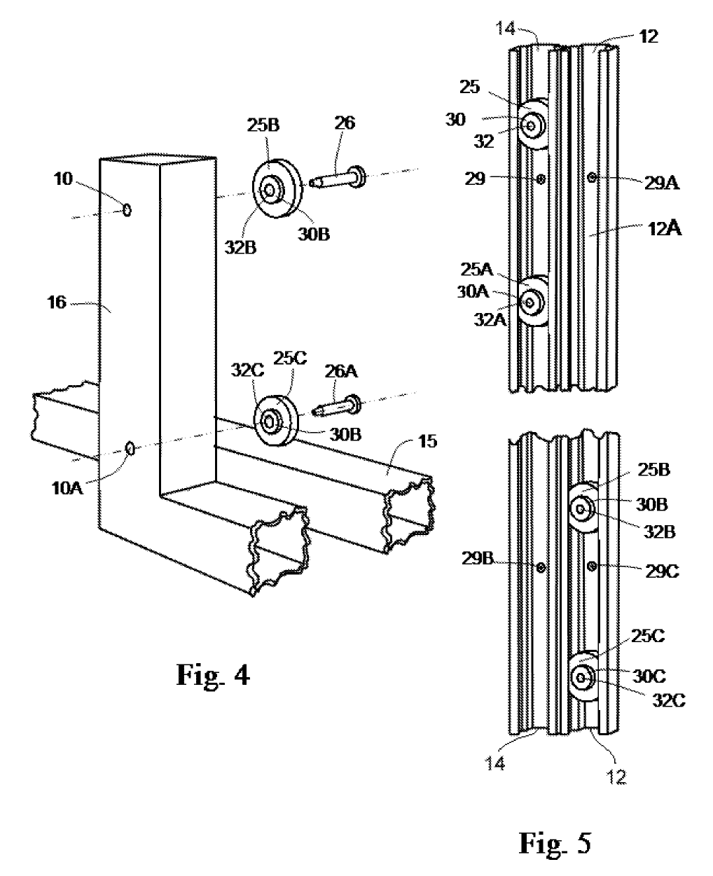

FIG. 4 shows a portion of the leftward L-shaped front deck support arm 16. Shoulder rivets 26 pass through idle rollers 25B and 25C traversing roller openings 32 and continue through openings 10 in L-shaped front deck support arm 16. The small tip of shoulder rivets 26 will protrude through openings 10 in L-shaped front deck support arm 16 and be swaged securely (not shown). The roller bosses 30 on rollers 25B and 25C will prevent the face of rollers 25B and 25C from binding against the surface of L-shaped front deck support arm 16. A portion of horizontal structural member 15 shows its orientation to the L-shaped front deck support arm 16. Similar mirror-image components (not shown) are duplicated on the rightward side of the front deck (not shown). The leftward and rightward L-shaped rear tray support arms (not shown) are similarly configured.

FIG. 5 shows the topmost and bottommost portions of the left rear tray track 14 and the left front deck track 12. Said tracks are affixed to the vertical support post 8 (not shown) by screws 29. Rollers 25, 25A, 25B and 25C configured with bosses 30 and roller openings 32 are slidably captured by their respective tracks 12 and 14. The upper rollers 25 and 25A are rotatably affixed to the leftward L-shaped rear tray support arm (shown in FIG. 1 as 9) by shoulder rivets (shown in FIG. 4 as 26). The lower rollers 25B and 25C are rotatably affixed to the leftward L-shaped front deck support arm (shown in FIG. 1 and FIG. 4 as 16). Similar mirror-image components (not shown) are duplicated on the outer (rightward) side of the rightward vertical support post 8A (not shown).

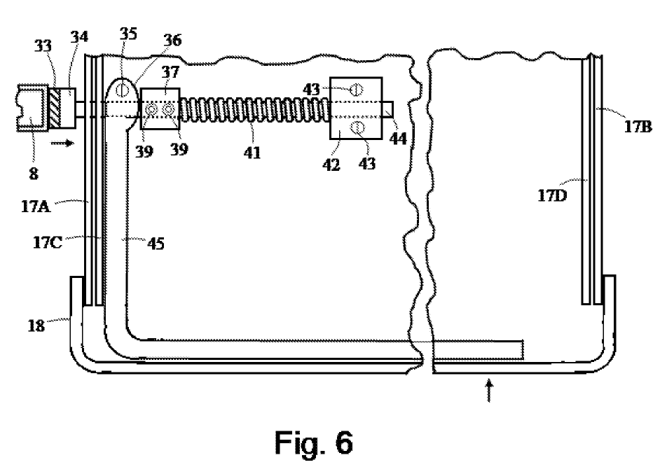

FIG. 6 is a top sectional view showing the brake mechanism within elastomeric boot 18 which is fitted over the open leftward end of the front deck plate flanges 17A 17B, 17C, and 17D. The brake spring block 42 is rigidly affixed to the front deck bottom plate (shown in FIG. 3 as 17E) by screws 43. Brake spring cam collar 37 is affixed to the brake rod 44 by screws 39. The brake compression spring 41 exerts outward pressure between brake spring block 42 and brake spring cam collar 37 and biases brake rod 44 which transmits said pressure to brake shoe 34 applying brake pad 33 to vertical support post 8 (partially shown) thereby locking front deck to vertical support post 8. Brake is releasably deployed by the operator manually compressing elastomeric boot 18, thereby rotating brake release arm 45 pivotingly mounted on shoulder bolt 35 affixed to front deck bottom plate (shown in FIG. 3 as 17E) thereby applying pressure to brake spring cam collar 37 thereby compressing brake spring 41 and withdrawing brake rod 44, brake shoe 34 and brake pad 33 from contact with vertical support post 8 (partially shown) thereby releasing the brake. Similar mirror-image components (not shown) are duplicated on rightward end of front deck 17 (not shown).

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. An adjustable height computer work stand, comprising:
a frame including two vertical support posts;
a front deck slidably affixed to said support posts being moveable between an uppermost and lowermost position, said deck adapted to horizontally support a computer display monitor, a keyboard and a mouse pad;
a rear counterbalance tray slidably affixed to said support posts being moveable between an uppermost and a lowermost position, said tray adapted to horizontally support a computer system case and computer accessories; and
cable and pulley means mechanically connecting said deck and said tray whereby said tray and said deck are counterbalanced such that the downward movement of said deck causes the upper movement of said tray.

2. The computer work stand of claim 1 wherein said support posts are located on opposite sides of said frame and between said front deck and said rear tray.

3. The computer work stand of claim 1 wherein said pulley means are supported on a shaft, which extends between said vertical support posts.

4. The computer work stand of claim 3 further including brake means for releasably securing said front deck to said vertical support posts.

5. The computer work stand of claim 4 further including brake release levers for temporarily releasing said brake means.

6. The computer work stand of claim 5 wherein said brake means are spring biased in the engaged position.

7. The computer work stand of claim 6 wherein said brake release levers are encased in elastomeric boots.

8. The computer work stand of claim 1 wherein the weight of said front deck, said computer display monitor, said keyboard and said mouse pad is approximately equal to the weight of said rear tray, said computer system case and said computer accessories.
